(19) United States
(12) Patent Application Publication
(10) Pub. No.: US 2021/0372157 A1
(43) Pub. Date: Dec. 2, 2021

(54) Digital Display Grave Marker Apparatus

(71) Applicants: Chris Damico, Rexburg, ID (US); Michelle Damico, Rexburg, ID (US)

(72) Inventors: Chris Damico, Rexburg, ID (US); Michelle Damico, Rexburg, ID (US)

(21) Appl. No.: 16/890,282

(22) Filed: Jun. 2, 2020

(51) Int. Cl. E04H 13/00; G09F 9/00; G09F 23/00; G09F 27/00; G09F 19/18; G06F 1/16; G06F 1/18

(52) U.S. Cl. CPC E04H 13/003; G09F 9/00; G09F 23/00; G09F 2027/002; G09F 19/18; G06F 1/1601; G06F 1/189; G09F 27/007

(57) ABSTRACT

A digital display grave marker apparatus for seeing and hearing the deceased includes a marker body having a body front side, a body back side, a body left side, a body right side, a body top side, and a body bottom side. A display screen is coupled to the body front side. A CPU is coupled within the marker body and is in operational communication with the display screen. A wireless transceiver is coupled within the marker body and is in operational communication with the CPU to interface with personal electronic devices. A memory card is coupled within the marker body and is in operational communication with the CPU. A battery is coupled within the marker body and is in operational communication with the CPU. A solar panel is coupled to the marker body and is in operational communication with the battery.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to grave stones and more particularly pertains to a new grave stone for seeing and hearing the deceased.

### (2) Description of Related Art Including Information Disclosed Under 37 CFR 1.97 and 1.98

The prior art relates to grave stones. Some existing devices are enhanced with audio and visual displays yet have limited connectivity with other devices to modify or enjoy the stored content. Existing devise also do not include a holographic projector.

### BRIEF SUMMARY OF THE INVENTION

An embodiment of the disclosure meets the needs presented above by generally comprising a marker body having a body front side, a body back side, a body left side, a body right side, a body top side, and a body bottom side. A display screen is coupled to the marker body. The display screen is coupled to the body front side. A CPU is coupled within the marker body and is in operational communication with the display screen. A wireless transceiver is coupled within the marker body and is in operational communication with the CPU and configured to interface with personal electronic devices. A memory card is coupled within the marker body and is in operational communication with the CPU. A battery is coupled within the marker body and is in operational communication with the CPU. A solar panel is coupled to the marker body and is in operational communication with the battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a digital display grave marker apparatus according to an embodiment of the disclosure.

FIG. 2 is a front elevation view of an embodiment of the disclosure.

FIG. 3 is a side elevation view of an embodiment of the disclosure.

FIG. 4 is a front elevation view of an embodiment of the disclosure.

FIG. 5 is a block diagram view of an embodiment of the disclosure.

### DETAILED DESCRIPTION OF THE INVENTION

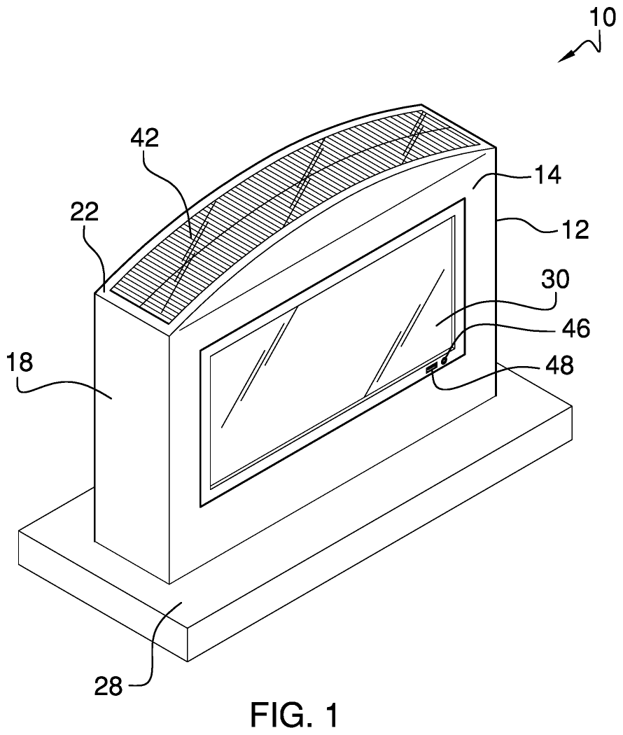

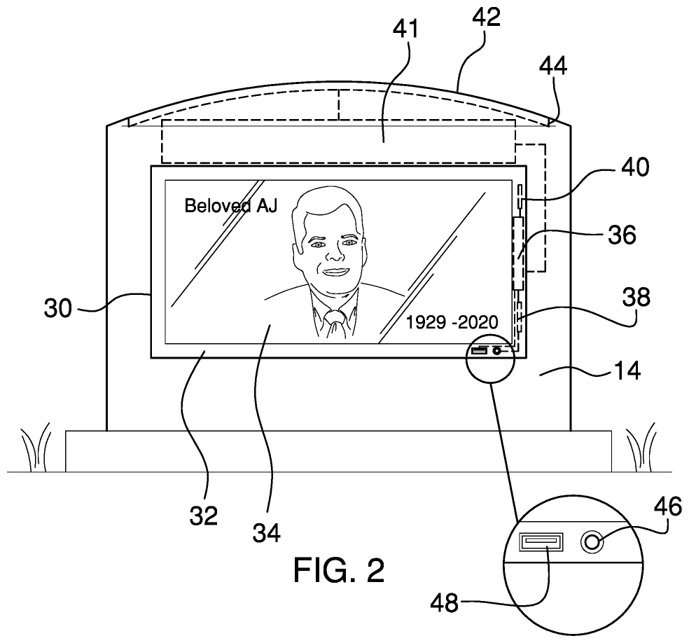

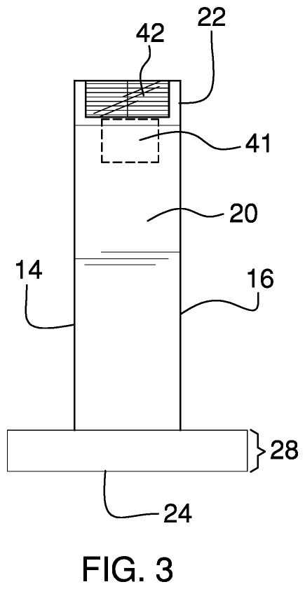

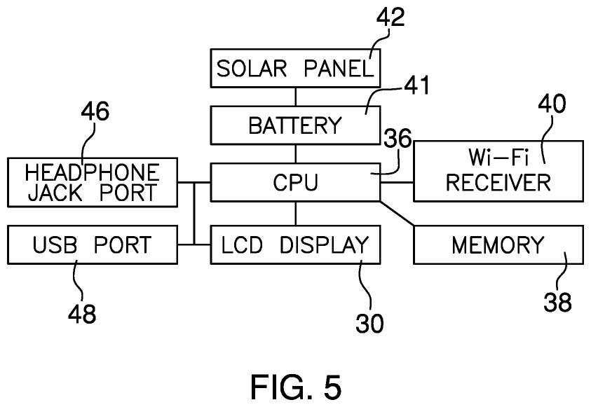

With reference now to the drawings, and in particular to FIGS. 1 through 5 thereof, a new grave stone embodying the principles and concepts of an embodiment of the disclosure and generally designated by the reference numeral 10 will be described.

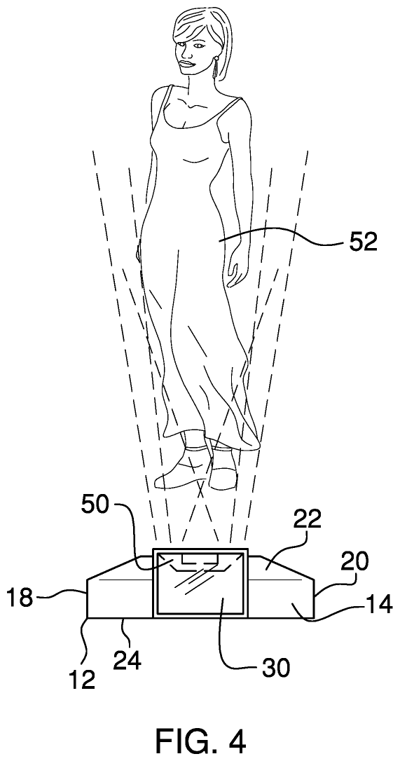

As best illustrated in FIGS. 1 through 5, the digital display grave marker apparatus 10 generally comprises a marker body 12 having a body front side 14, a body back side 16, a body left side 18, a body right side 20, a body top side 22, and a body bottom side 24. The body front side 14 may have a screen aperture 26. The body top side 22 may be arched or may alternatively be a trapezoidal prism as shown in FIG. 4. The body bottom side 16 may have an extended rectangular prismatic base portion 28.

A display screen 30 is coupled to the marker body 12. The display screen 30 may be coupled to the body front side 14 within the screen aperture 26 such that it rests flush with the body front side 14. The display screen 30 has a perimeter portion 32 and a screen portion 34. A CPU 36 is coupled within the marker body 12 and is in operational communication with the display screen 30. A memory card 38 is coupled within the marker body 12 and is in operational communication with the CPU 36 to display images or videos on the display screen 30.

A wireless transceiver 38 is coupled within the marker body 12 and is in operational communication with the CPU 36. The wireless transceiver 38 is configured to interface with personal electronic devices and the internet to load new images and videos on the memory card 38. The wireless transceiver 38 may also be used to reproduce images and video directly from the internet or personal electronic devices on the display screen 30. The wireless transceiver 38 may be a standardized wireless technology such as, but not limited to, wi-fi, Bluetooth, LTE, or the like.

A battery 41 is coupled within the marker body 12 and is in operational communication with the CPU 36. A solar panel 42 is coupled to the marker body 12 and in operational communication with the battery 40. The solar panel 42 may be coupled within a panel depression 44 of the body top side 22 such that it rests flush with the body top side 22. The solar panel 42 may occupy at least 90% of the area of the body top side 22 to maximize capability to recharge the battery 40.

A headphone jack port 46 is coupled to the display screen 30. The headphone jack port 46 is coupled within the perimeter portion 32 and is in operational communication with the CPU 36 to play audio stored on the memory card 38 or reproduced through the wireless transceiver 38. A USB port 48 may be coupled to the display screen 30. The USB port 48 is coupled within the perimeter portion 32 and is in operational communication with the CPU 36 to provide an alternative means of transferring audio and video to the memory card 38 or for direct reproduction on the display screen 30.

In some embodiments a holographic projector 50 may be coupled to the marker body 12. The holographic projector 50 may be coupled to the body top side 22 or to the body back side 16 and oriented up towards the body top side 22. The holographic projector 50 is in operational communication with the CPU 36 to project a holographic image 52 above the marker body 12 as shown in FIG. 4.

In use, visitors to the digital display grave marker apparatus 10 may watch video and see images of the deceased that are either stored on the memory card 38 or reproduced via the wireless transceiver 38 or the USB port 48. They may also listen to audio using the headphone jack port 46 in order to hear the voice and listen to memories and advice.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A digital display grave marker apparatus comprising:
a marker body having a body front side, a body back side, a body left side, a body right side, a body top side, and a body bottom side;
a display screen coupled to the marker body, the display screen being coupled to the body front side;
a CPU coupled within the marker body, the CPU being in operational communication with the display screen;
a wireless transceiver coupled within the marker body, the wireless transceiver being in operational communication with the CPU and configured to interface with personal electronic devices;
a memory card coupled within the marker body, the memory card being in operational communication with the CPU;
a battery coupled within the marker body, the battery being in operational communication with the CPU; and
a solar panel coupled to the marker body, the solar panel being in operational communication with the battery.

2. The digital display grave marker apparatus of claim 1 further comprising the body front side having a screen aperture; the display screen being coupled within the screen aperture such that it rests flush with the body front side.

3. The digital display grave marker apparatus of claim 1 further comprising the display screen having a perimeter portion and a screen portion.

4. The digital display grave marker apparatus of claim 3 further comprising a headphone jack port coupled to the display screen, the headphone jack port being coupled within the perimeter portion and being in operational communication with the CPU.

5. The digital display grave marker apparatus of claim 3 further comprising a USB port coupled to the display screen, the USB port being coupled within the perimeter portion and being in operational communication with the CPU.

6. The digital display grave marker apparatus of claim 1 further comprising the solar panel being coupled to the body top side.

7. The digital display grave marker apparatus of claim 7 further comprising the solar panel being coupled within a panel depression of the body top side such that it rests flush with the body top side.

8. The digital display grave marker apparatus of claim 7 further comprising the solar panel occupying at least 90% of the area of the body top side.

9. The digital display grave marker apparatus of claim 1 further comprising the body top side being arched.

10. The digital display grave marker apparatus of claim 1 further comprising the body bottom side having an extended rectangular prismatic base portion.

11. The digital display grave marker apparatus of claim 1 further comprising a holographic projector coupled to the marker body, the holographic projector being coupled to the body top side and being in operational communication with the CPU to project a holographic image above the marker body.

12. The digital display grave marker apparatus of claim 1 further comprising the body top side being a trapezoidal prism.

13. A digital display grave marker apparatus comprising:
a marker body having a body front side, a body back side, a body left side, a body right side, a body top side, and a body bottom side, the body front side having a screen aperture, the body top side being arched, the body bottom side having an extended rectangular prismatic base portion;
a display screen coupled to the marker body, the display screen being coupled to the body front side within the screen aperture such that it rests flush with the body front side, the display screen having a perimeter portion and a screen portion;
a CPU coupled within the marker body, the CPU being in operational communication with the display screen;
a wireless transceiver coupled within the marker body, the wireless transceiver being in operational communication with the CPU and configured to interface with personal electronic devices;
a memory card coupled within the marker body, the memory card being in operational communication with the CPU;
a battery coupled within the marker body, the battery being in operational communication with the CPU;
a solar panel coupled to the marker body, the solar panel being in operational communication with the battery, the solar panel being coupled within a panel depression of the body top side such that it rests flush with the body top side, the solar panel occupying at least 90% of the area of the body top side;
a headphone jack port coupled to the display screen, the headphone jack port being coupled within the perimeter portion and being in operational communication with the CPU;
a USB port coupled to the display screen, the USB port being coupled within the perimeter portion and being in operational communication with the CPU; and
a holographic projector coupled to the marker body, the holographic projector being coupled to the body top side and being in operational communication with the CPU to project a holographic image above the marker body.
